(19) United States
(12) Patent Application Publication
(10) Pub. No.: US 2025/0319600 A1
(43) Pub. Date: Oct. 16, 2025

(54) Method of Controlling Movements of Industrial Robot, and Robot System

(71) Applicant: ABB Schweiz AG, Baden (CH)

(72) Inventor: Anders Spaak, Göteborg (SE)

(21) Appl. No.: 18/866,389

(22) PCT Filed: May 23, 2022
(86) PCT No.: PCT/EP2022/063916

§ 371 Date: Nov. 15, 2024

(51) Int. Cl. B25J 9/16; B25J 13/08; B33Y 50/02

(52) U.S. Cl. CPC B25J 9/1687; B25J 13/08; B33Y 50/02; G05B 2219/39001

(57) ABSTRACT

A method of controlling movements of an industrial robot in relation to a surface, the method including providing a plurality of candidate target points for the industrial robot in an offline programming system; providing a plurality of actual reference points in the offline programming system, the actual reference points being indicative of a true profile of the surface; modifying the candidate target points in the offline programming system based on the actual reference points to provide a plurality of modified target points for the industrial robot; providing a target robot program for the industrial robot based on the modified target points; and executing the target robot program in a robot controller to thereby cause the industrial robot to perform movements in relation to the surface.

### TECHNICAL FIELD

The present disclosure generally relates to movement control of industrial robots. In particular, a method of controlling movements of an industrial robot in relation to a surface, and a robot system comprising an industrial robot, an offline programming system and a robot controller, are provided.

### BACKGROUND

Additive manufacturing of large three-dimensional products using industrial robots is a rapidly increasing production method. This production method may be used in various different fields and with various different materials, such as plastics, concrete and metal.

US2016176115 A1 discloses a printing system for printing three-dimensional objects. The printing system comprises a control unit and an industrial robot controlled by the control unit. The industrial robot carries a printing unit having a printing nozzle for applying pointwise a respective portion of a print material at respective coordinates according to object data of a robot program. The printing system can print large objects, such as an object having a width of 2 m (meters), a depth of 2 m and a height of 2 m.

When printing a large object by additive manufacturing using an industrial robot, a surface on which the printing takes place may not be perfectly flat. If a robot program in this case is designed based on an assumption that the surface is flat, a collision between a print tool and the surface may occur. Moreover, the printing performance is deteriorated if a distance between the print tool and the surface differs from an intended distance. A large object may in this regard be an object having a width of at least 2 m, a depth of at least 2 m and a height of at least 2 m.

In order to enable printing on an uneven surface using an industrial robot, several different reference coordinate systems defined in relation to the surface may be used. For example, a first reference coordinate system may be set for a relatively low region of the surface and a second reference coordinate system may be set for a relatively high region of the surface. However, to switch between reference coordinate systems during printing with the industrial robot is not desirable. For example, a very high number (such as millions) of target points for the industrial robot may be needed when printing a large object. This results in a need to dynamically load the robot program to a robot controller during printing due to a limited capacity of a working memory in the robot controller. It is however difficult to switch between reference coordinate systems during the printing and the printing performance will be deteriorated by the interruption. Moreover, to set a plurality of reference coordinate systems in relation to the surface is time consuming and difficult for many users.

### SUMMARY

One object of the invention is to provide an improved method of controlling movements of an industrial robot in relation to a surface.

A further object of the invention is to provide an improved robot system.

These objects are achieved by the method and the robot system according to the claims.

The invention is based on the realization that by modifying target points for an industrial robot in an offline programming system based on actual reference points indicative of a true profile of a surface, the method can more efficiently handle a particular true shape of the surface and movements of the industrial robot in relation to the surface will be more accurate. Moreover, this concept efficiently enables a user to provide various inputs, such as how the robot program should be modified, and enables an efficient control of an industrial robot also in relation to various non-planar surfaces, such as spherical surfaces.

According to a first aspect, there is provided a method of controlling movements of an industrial robot in relation to a surface, the method comprising providing a plurality of candidate target points for the industrial robot in an offline programming system; providing a plurality of actual reference points in the offline programming system, the actual reference points being indicative of a true profile of the surface; modifying the candidate target points in the offline programming system based on the actual reference points to provide a plurality of modified target points for the industrial robot; providing a target robot program for the industrial robot based on the modified target points; and executing the target robot program in a robot controller to thereby cause the industrial robot to perform movements in relation to the surface.

By modifying the candidate target points in the offline programming system to provide the modified target points, the target robot program will match the real physical world without the need to use a plurality of reference coordinate systems. Thus, instead of using multiple reference coordinate systems for the control of the industrial robot, the candidate target points are modified in the offline programming system based on the actual reference points to provide the modified target points. The modified target points in turn form the basis for the creation of the target robot program that is executed in the robot controller. This way of providing the target robot program according to the method is also more accurate and less computationally heavy than modifying a robot program that has already been generated directly based on the candidate target points. Although the need to use a plurality of reference coordinate systems is eliminated, the method may optionally use multiple reference coordinate systems.

The method may be used in various additive manufacturing processes, in particular for manufacturing large objects, e.g. objects having a width of at least 2 m, a depth of at least 2 m and a height of at least 2 m. The method is however not limited to additive manufacturing processes. The method can also be used for various path-following processes, such as welding processes and gluing processes performed by the industrial robot relative to the surface.

The industrial robot may comprise a manipulator movable relative to a base. The base may or may not be stationary. According to one example, the base is positioned on a movable conveyor such that the base can move linearly.

The target robot program may comprise a plurality of movement instructions for the industrial robot to cause movements along movement segments between adjacent modified target points when executed by the robot controller. The target robot program may be provided in a computer numerical control (CNC) programming language, such as in G-code or RAPID code used by ABB.

The offline programming system and the robot controller may be functionally and physically separated from each other. The offline programming system is offline in the sense that it does not directly control the industrial robot, in contrast to the robot controller which is online. The offline programming system may however be connected to, for example, the Internet. The offline programming system may comprise software for robot programming and robot simulation. The software may also comprise a virtual copy of the industrial robot and optionally of the surface.

The modification of the candidate target points may additionally be made based on a user modification input indicative of a type of modification of the candidate target points. This enables a user to at least partly determine how the movements of the industrial robot in relation to the surface should be performed given the true profile of the surface.

The provision of the actual reference points may comprise providing a plurality of candidate reference points; and determining the actual reference points based on the candidate reference points. For example, one actual reference point may be determined for each candidate reference point.

The candidate target points may be provided based on the candidate reference points.

The method may further comprise providing, in the offline programming system, a candidate orientation for an end effector of the industrial robot associated with one of the candidate target points; modifying, in the offline programming system, the candidate orientation based on one or more of the actual reference points to provide a modified orientation for the end effector, different from the candidate orientation; and associating the modified orientation with the modified target point associated with the one candidate target point; wherein the target robot program is additionally provided based on the modified orientation. The method of this variant enables efficient modification of end effector orientations prior to generation of the target robot program. This way of modifying end effector orientations is more efficient than modifying end effector orientations in an already generated robot program.

The end effector may be carried by the manipulator of the industrial robot. The end effector may for example be a print tool, a welding tool or a laser tool. The end effector may be used to deposit, joint or solidify a material to form an object. The material may for example be plastics, concrete or metal. The end effector may for example provide a heat source, such as a laser or electron beam, to heat powder in a powder bed so that it consolidates to form the object. Alternatively, the print tool may deposit the material, such as plastics or concrete, layer by layer.

The end effector may be positioned in a single position in various different orientations. Conversely, the end effector may be oriented in a single orientation in various different positions. A combination of a position and an orientation of the end effector may be referred to as a pose.

The method may comprise for each candidate reference point, controlling the industrial robot to move to measure a position of the surface associated with the candidate reference point; and determining the actual reference points based on the candidate reference points and the measured positions. The same industrial robot may thus be used both to measure positions on the surface and to perform the target robot program.

The method may comprise providing the candidate reference points in the offline programming system; providing a measurement robot program for the industrial robot based on the candidate reference points; and executing the measurement robot program in the robot controller to thereby cause the industrial robot to move to measure the positions of the surface associated with the candidate reference points.

To this end, a plurality of measurement target points may be provided in the offline programming system where each measurement target point is associated with a unique candidate reference point. Each measurement target point may for example be offset a default distance from the associated candidate reference point. The measurement robot program may be generated based on the measurement target points and then executed by the robot controller.

The measurement robot program may comprise a plurality of movement instructions for the industrial robot to cause movements along movement segments between adjacent measurement target points when executed by the robot controller. The measurement robot program may be provided in a computer numerical control (CNC) programming language, such as RAPID code used by ABB.

The method may further comprise selecting a measurement method of the positions of the surface associated with the candidate reference points among a plurality of different measurements methods based on a user measurement input; and controlling the industrial robot to measure the positions of the surface associated with the candidate reference points based on the selected measurement method.

The different measurement methods may comprise use of different types of position sensors to be carried by the industrial robot.

The target robot program may be an additive manufacturing robot program for controlling the industrial robot to perform additive manufacturing on the surface.

The movements of the industrial robot in relation to the surface may span over at least 2 meters.

The industrial robot may comprise at least six axes.

According to a second aspect, there is provided a robot system comprising an industrial robot; an offline programming system; and
a robot controller; wherein the offline programming system comprises at least one first data processing device and at least one first memory having at least one first computer program stored thereon, the at least one first computer program comprising program code which, when executed by the at least one first data processing device, causes the at least one first data processing device to perform the steps of providing a plurality of candidate target points for the industrial robot; providing a plurality of actual reference points, the actual reference points being indicative of a true profile of the surface;
modifying the candidate target points based on the actual reference points to provide a plurality of modified target points for the industrial robot; providing a target robot program for the industrial robot based on the modified target points; and wherein the robot controller comprises at least one second data processing device and at least one second memory having at least one second computer program stored thereon, the at least one second computer program comprising program code which, when executed by the at least one second data processing device, causes the at least one second data processing device to perform the step of executing the target robot program to thereby cause the industrial robot to perform movements in relation to the surface.

The at least one first computer program or the at least one second computer program may further comprise program code which, when executed by the at least one first data processing device or the at least one second data processing device, respectively, causes performance or command of performance of various steps as described herein.

The at least one first computer program may comprise program code which, when executed by the at least one first data processing device, causes the candidate target points to additionally be modified based on a user modification input indicative of a type of modification of the candidate target points based on the actual reference points to provide the modified target points.

The at least one first computer program may comprise program code which, when executed by the at least one first data processing device, causes providing a plurality of candidate reference points; and determining the actual reference points based on the candidate reference points.

The at least one first computer program may comprise program code which, when executed by the at least one first data processing device, causes the candidate target points to be provided based on the candidate reference points.

The at least one first computer program may comprise program code which, when executed by the at least one first data processing device, causes provision of a candidate orientation for an end effector of the industrial robot associated with one of the candidate target points; modification of the candidate orientation based on one or more of the actual reference points to provide a modified orientation for the end effector, different from the candidate orientation; and association of the modified orientation with the modified target point associated with the one candidate target point; wherein the target robot program is additionally provided based on the modified orientation.

The at least one second computer program may comprise program code which, when executed by the at least one second data processing device, causes control of the industrial robot to move to measure a position of the surface associated with the candidate reference point. In this case, the at least one first computer program may comprise program code which, when executed by the at least one first data processing device, causes determination of the actual reference points based on the candidate reference points and the measured positions.

The at least one first computer program may comprise program code which, when executed by the at least one first data processing device, causes provision of the candidate reference points; and provision of a measurement robot program for the industrial robot based on the candidate reference points. In this case, at least one second computer program may comprise program code which, when executed by the at least one second data processing device, causes execution of the measurement robot program in the robot controller to thereby cause the industrial robot to move to measure the positions of the surface associated with the candidate reference points.

The at least one first computer program may comprise program code which, when executed by the at least one first data processing device, causes selection of a measurement method of the positions of the surface associated with the candidate reference points among a plurality of different measurements methods based on a user measurement input. In this case, the at least one second computer program may comprise program code which, when executed by the at least one second data processing device, causes control of the industrial robot to measure the positions of the surface associated with the candidate reference points based on the selected measurement method.

The different measurement methods may comprise use of different types of position sensors to be carried by the industrial robot. The robot system may thus further comprise a plurality of position sensors of different types, each configured to be carried by the industrial robot, either simultaneously or one at a time. The one or more position sensors may or may not be carried by the manipulator simultaneously with the end effector.

Also in the second aspect, the target robot program may be an additive manufacturing robot program for controlling the industrial robot to perform additive manufacturing on the surface.

Also in the second aspect, the movements of the industrial robot in relation to the surface may span over at least 2 meters.

Also in the second aspect, the industrial robot may comprise at least six axes. The industrial robot may for example comprise a manipulator having six or seven joints and six or seven links, such as a serial manipulator or a parallel manipulator.

The method according to the first aspect may use a robot system of any type according to the second aspect.

### BRIEF DESCRIPTION OF THE DRAWINGS

Further details, advantages and aspects of the present disclosure will become apparent from the following description taken in conjunction with the drawings, wherein:

FIG. 1: schematically represents a perspective view of a robot system comprising an industrial robot performing movements in relation to a surface;

FIG. 2: schematically represents a side view of the surface and candidate reference points, candidate target points and measurement target points in relation to the surface;

FIG. 3: schematically represents side views of two examples of position sensors;

FIG. 4: schematically represents one example of information on a display when a user provides a user measurement input;

FIG. 5: schematically represents a side view of the surface and candidate reference points and actual reference points in relation to the surface;

FIG. 6: schematically represents one example of information on the display when a user provides a user modification input;

FIG. 7: schematically represents a side view of the surface and reference points and modified target points in relation to the surface; and

FIG. 8: schematically represents a candidate orientation for an end effector in a candidate target point in relation to candidate reference points and a modified orientation for the end effector in a modified target point in relation to actual reference points.

### DETAILED DESCRIPTION

In the following, a method of controlling movements of an industrial robot in relation to a surface, and a robot system comprising an industrial robot, an offline programming system and a robot controller, will be described. The same or similar reference numerals will be used to denote the same or similar structural features.

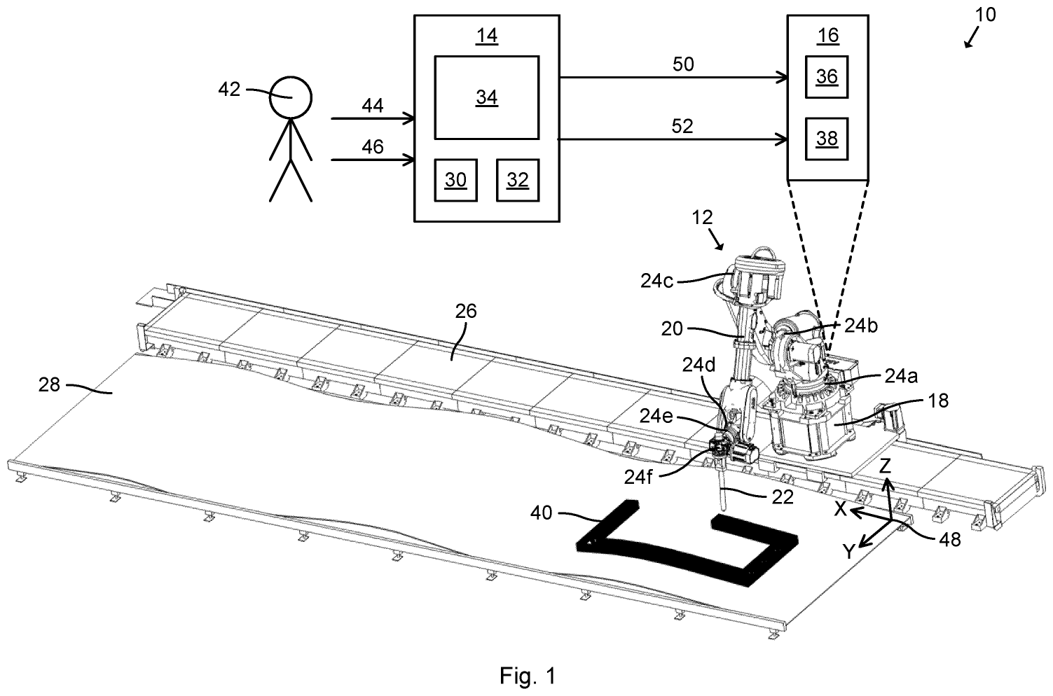

FIG. 1 schematically represents a perspective view of a robot system 10. The robot system 10 comprises an industrial robot 12, an offline programming system 14 and a robot controller 16.

The industrial robot 12 comprises a base 18, a manipulator 20 movable relative to the base 18 and an end effector, here exemplified as a print tool 22, carried by the manipulator 20. The manipulator 20 of this example comprises six axes 24a-24f.

The robot system 10 of this example further comprises a conveyor 26. The base 18 is positioned on the conveyor 26 such that the industrial robot 12 can move linearly.

FIG. 1 further shows a surface 28. In this specific and non-limiting example, the surface 28 has a width of 10 m and a depth of 3 m. As shown in FIG. 1, the surface 28 is wave-formed and not perfectly flat. The conveyor 26 and the industrial robot 12 can be controlled such that print tool 22 can reach every position on the surface 28.

The offline programming system 14 of this example comprises a first data processing device 30 and a first memory 32. The first memory 32 has a first computer program stored thereon. The first computer program comprises program code which, when executed by the first data processing device 30, causes the first data processing device 30 to perform, or command performance of, various steps as described herein. The offline programming system 14 further comprises a display 34. The offline programming system 14 may for example be constituted by a personal computer (PC).

Robot programming and robot simulation software is implemented in the offline programming system 14. One example of such software is RobotStudio® by ABB. A digital twin or virtual copy of the robot controller 16, the industrial robot 12, the conveyor 26 and the surface 28 is also implemented in the offline programming system 14.

The robot controller 16 is configured to control the industrial robot 12. In this example, the robot controller 16 is also configured to control the conveyor 26. The robot controller 16 of this example comprises a second data processing device 36 and a second memory 38. The second memory 38 has a second computer program stored thereon. The second computer program comprises program code which, when executed by the second data processing device 36, causes the second data processing device 36 to perform, or command performance of, various steps as described herein.

The industrial robot 12 is controlled to perform movements in relation to the surface 28, here to print an object 40 on the surface 28 by additive manufacturing. The print tool 22 deposits material layer by layer on the surface 28 to form the object 40. The surface 28 thus here functions as a printbed. The robot system 10 for example enables printing with concrete directly on a rock.

FIG. 1 further shows a human user 42. The user 42 interacts with the offline programming system 14. The user 42 can for example provide a user measurement input 44 and a user modification input 46 to the offline programming system 14, as described below.

FIG. 1 further shows a reference coordinate system 48. The reference coordinate system 48 is here an orthogonal coordinate system comprising an X-axis, a Y-axis and a Z-axis. The reference coordinate system 48 may be initially set by the user 42 in the offline programming system 14.

FIG. 1 further illustrates transmission of a measurement robot program 50, generated in the offline programming system 14, from the offline programming system 14 to the robot controller 16 for execution by the robot controller 16. FIG. 1 further illustrates transmission of a target robot program 52, generated in the offline programming system 14, from the offline programming system 14 to the robot controller 16 for execution by the robot controller 16.

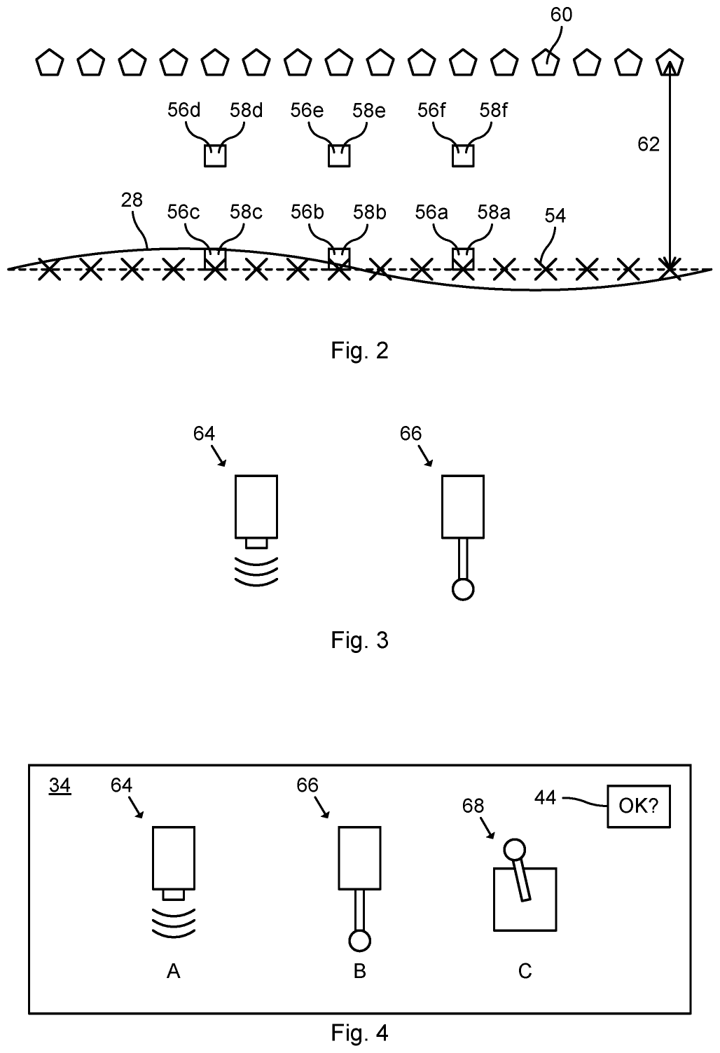

FIG. 2 schematically represents a side view of the surface 28. The view in FIG. 2 and similar views, for example without the surface 28, may be displayed on the display 34. In the offline programming system 14, a plurality of nominal or candidate reference points 54 are provided, here illustrated as crosses. The candidate reference points 54 constitute an initial representation of the surface 28 in the offline programming system 14.

In this example, the candidate reference points 54 are positioned in a two-dimensional grid in the XY-plane. The offsets between the candidate reference points 54 in each of the X-direction and the Y-direction may for example be 40 mm.

The candidate reference points 54 may be determined by the offline programming system 14 based on a model of the surface 28, such as a CAD (computer aided design) model. The number of candidate reference points 54 provided in the offline programming system 14 can be set or adjusted by the user 42. A higher number of selected candidate reference points 54 will generate a more accurate representation of the surface 28, and consequentially a more accurate control of the industrial robot 12, as described below.

As shown in FIG. 2, the representation of the surface 28 by the candidate reference points 54 is perfectly flat. However, as also illustrated in FIG. 2, the true shape of the surface 28 is not flat.

FIG. 2 further shows a plurality of candidate target points 56a-56f for the print tool 22, here illustrated as squares. In this example, a candidate orientation 58a-58f for the print tool 22 is also associated with each candidate target point 56a-56f. Each pair of a candidate orientation 58a-58f and a candidate target point 56a-56f form a candidate pose for the print tool 22. In FIG. 2, each candidate orientation 58a-58f is identic, here illustrated by vertical orientations of the squares which in turn represent vertical orientations of the print tool 22. The candidate target points 56a-56f are defined in the offline programming system 14, e.g. as coordinates in the reference coordinate system 48. Also, the candidate orientations 58a-58f are defined in the offline programming system 14. The candidate target points 56a-56f and the candidate orientations 58a-58f may be set by the user 42, may be automatically generated and/or may be imported to the offline programming system 14.

The candidate target points 56a-56f and the candidate orientations 58a-58f may be used to create a robot program in the offline programming system 14. When the robot program is executed in the robot controller 16, the industrial robot 12 is controlled such that the print tool 22 (or other tool center point) moves sequentially in movement segments to each candidate target points 56a-56f and with the respective candidate orientation 58a-58f.

As shown in FIG. 2, the first candidate target point 56a is vertically separated from the surface 28. Thus, in case a robot program is generated based on this first candidate target point 56a, the separation will deteriorate the quality of the printing. Moreover, the third candidate target point 56c is positioned below the surface 28. This causes a risk of collision between the print tool 22 and the surface 28 when a corresponding robot program is run on the robot controller 16. When printing the object 40, it may for example be desirable that the print tool 22 is positioned 1 mm above the surface 28 at each target point (in a layer of target points most adjacent to the surface 28).

In case all candidate target points 56a-56f are collectively raised in the offline programming system 14, the risk of collision between the print tool 22 and the surface 28 can be avoided in a subsequently generated robot program. However, the first candidate target point 56a will then be further vertically separated from the surface 28 to further deteriorate the quality of the additive manufacturing.

FIG. 2 further shows a plurality of measurement target points 60 provided in the offline programming system 14, here illustrated as pentagons. The measurement target points 60 are used to generate the measurement robot program 50. Each measurement target point 60 is offset from an associated candidate reference point 54 with a distance 62. The distance 62 may for example be a vertical distance of 100 mm. The measurement target points 60 may be automatically generated.

FIG. 3 schematically represents side views of a distance position sensor 64 and a touch position sensor 66. The distance position sensor 64 can measure a position of the surface 28 at a distance from the surface 28. The touch position sensor 66 can measure a position of the surface 28 by being brought into contact with the surface 28. Each of the distance position sensor 64 and the touch position sensor 66 can be carried by the manipulator 20. The manipulator 20 may or may not carry the print tool 22 at the same time.

FIG. 4 schematically represents one example of information displayed on the display 34. The user 42 can select between different types of measurements. In FIG. 4, option A is a measurement using the distance position sensor 64, option B is a measurement using the touch position sensor 66, and option C is a manual jogging of the industrial robot 12 using a programming device 68, such as a teach pendant unit. The user 42 provides the user measurement input 44 to the offline programming system 14 via the display 34. In this example, the user 42 selects the distance position sensor 64 for the measurements.

The user 42 may also set a measurement orientation for the distance position sensor 64 at one or more of the measurement target points 60. In this specific example, the same measurement orientation is however set for all measurement target points 60.

The measurement robot program 50 is then created in the offline programming system 14 based on the measurement target points 60 (and optionally based on particular measurement orientations) and is transferred to the robot controller 16. In addition to the measurement target points 60, the measurement robot program 50 contains movement instructions for the industrial robot 12, such as RAPID code used by ABB. The measurement robot program 50 may be created either before or after the user 42 provides the user measurement input 44.

When the measurement robot program 50 is executed by the robot controller 16, the robot controller 16 controls the industrial robot 12 to position the distance position sensor 64 at the distance 62 above each candidate reference point 54 and to measure the distance to the surface 28. In this way, positions of the surface 28 associated each candidate reference point 54 are measured. The distance from the distance position sensor 64 to the surface 28 will vary between different measurement target points 60 since the surface 28 is not flat. The robot controller 16 adds the measurement results to a list containing the candidate reference points 54. When measurements have been performed at all candidate reference points 54, the list is sent from the robot controller 16 to the offline programming system 14, for example in text format.

In case the touch position sensor 66 is selected by the user 42 (option B), the industrial robot 12 will move to each measurement target point 60 above the respectively associated candidate reference points 54 and then bring the touch position sensor 66 into contact with the surface 28. The distances moved by the industrial robot 12 from the measurement target points 60 to the surface 28 will then be taken as the measurements results.

In case the programming device 68 is selected by the user 42 (option C), the industrial robot 12 will move to each measurement target point 60 above the respectively associated candidate reference points 54. At each measurement target point 60, the user 42 jogs the industrial robot 12 (such as the print tool 22 thereof) into contact with, or close to, the surface 28 using the programming device 68. In this case, no position sensor is needed. The jogging distances by the industrial robot 12 from each measurement target point 60 to the surface 28, or the positions of the industrial robot 12 when contacting the surface 28, will then be taken as the measurement results.

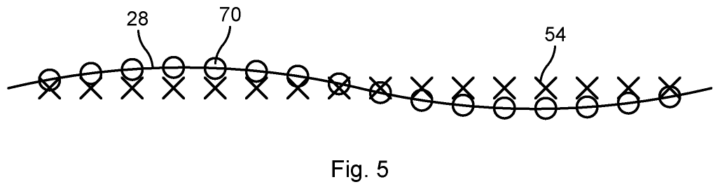

FIG. 5 schematically represents a side view of the surface 28. The view in FIG. 5 and similar views, for example without the surface 28, may be displayed on the display 34. In the offline programming system 14, a plurality actual reference points 70 are provided based on the candidate reference points 54 and the measurement results, here represented as circles. The offline programming system 14 calculates the actual reference points 70 based on the candidate reference points 54 and the position measurements with the distance position sensor 64 by the industrial robot 12. The actual reference points 70 constitute a true representation of the actual profile of the surface 28 in the offline programming system 14. The surface 28 has now been calibrated such that information of the true shape of the surface 28 is provided in the offline programming system 14.

Each actual reference point 70 is associated with a candidate reference point 54. The actual reference points 70 here differ from the associated candidate reference points 54 only in the Z-direction. The candidate reference points 54 are thus modified based on the measurements of the surface 28 to provide actual reference points 70 that coincide with the surface 28. Also, the actual reference points 70 may be defined as coordinates in the reference coordinate system 48.

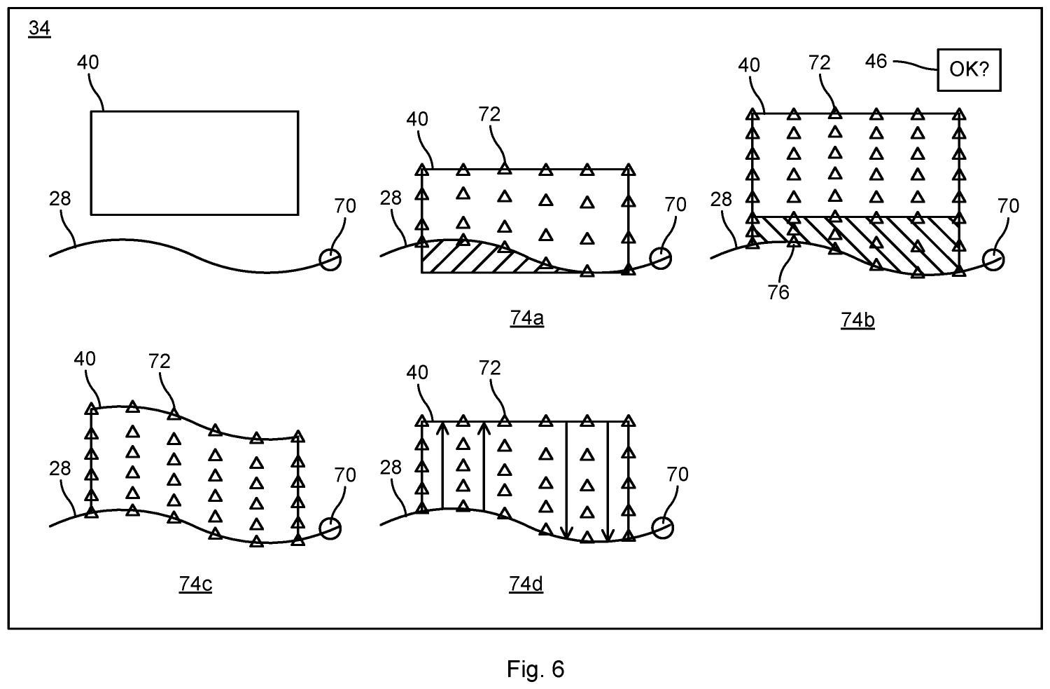

FIG. 6 schematically represents a further example of information displayed on the display 34. The user 42 is now presented with the option to determine how the candidate target points 56a-56f should be modified based on the actual reference points 70 to provide modified target points 72, here represented with triangles, for the industrial robot 12. Also, the modified target points 72 are defined in the offline programming system 14, e.g. as coordinates in the reference coordinate system 48. The object 40 and the surface 28, represented by the actual reference points 70, are displayed on the display 34. In this example, the display 34 shows four predetermined different types of modifications 74a-74d of the candidate target points 56a-56f that the user 42 can select between. The types of modifications 74a-74d can be automatically generated by the offline programming system 14. In all these non-limiting examples of types of modifications 74a-74d, the shape of printing material will be modified relative to an original shape of the object 40 (e.g. from a CAD model) due to the non-flat shape of the surface 28.

In the first type of modification 74a, the candidate target points 56a-56f are modified based on the actual reference points 70 to provide modified target points 72 such that a lowest portion of an original shape of the object 40 will be aligned with a lowest portion of the surface 28. A peak region of the surface 28 prevents a part of the original shape of the object 40 from being printed. The modified target points 72 are vertically compressed above the peak region of the surface 28.

In the second type of modification 74b, the candidate target points 56a-56f are modified based on the actual reference points 70 to provide modified target points 72 such that the entire original shape of the object 40 is above the surface 28. Further target points 76 (not corresponding to any of the candidate target points 56a-56f) are also added below the object 40 such that printing material is added between the original shape of the object 40 and the surface 28.

In the third type of modification 74c, the candidate target points 56a-56f are modified based on the actual reference points 70 to provide modified target points 72 such that each horizontal group of modified target points 72 provides a shape matching the shape of the surface 28. In this example, this causes the entire object 40 to be wave-formed. No printing material beyond the printing material corresponding to the originally planned object 40 has to be added, and no printing material has to be removed in comparison with the original object 40.

In the fourth type of modification 74d, the candidate target points 56a-56f are modified based on the actual reference points 70 to provide modified target points 72 such that some vertical columns of modified target points 72 are vertically compressed above a peak region of the surface 28, and some vertical columns of modified target points 72 are vertically expanded above a valley region of the surface 28.

Due to the display of information as exemplified in FIG. 6, the user 42 can easily understand how the actual printing will be performed in relation to the true shape of the surface 28. The types of modifications 74a-74d only constitute some of many examples. The user 42 may modify the candidate target points 56a-56f based on the actual reference points 70 to provide the modified target points 72, and possibly add further target points 76, in various different ways with more or less assistance from the offline programming system 14. In addition to being repositioned, the object 40, as modelled in the offline programming system 14, and for which the candidate target points 56a-56f are provided, may also be reshaped with respect to the surface 28 (represented by the actual reference points 70). Thus, the user 42 can also change the scaling of the object 40 in relation to the surface 28. Such change of the scaling is very difficult to make in an already generated robot program.

In any case, the user 42 then provides the user modification input 46 to the offline programming system 14. In response to the user modification input 46, the offline programming system 14 determines the modified target points 72 based on the candidate target points 56a-56f and the actual reference points 70. The candidate target points 56a-56f are thus modified in a manner selected by the user 42 to provide the modified target points 72a-72f.

For each of the types of modifications 74a-74d, each candidate target point 56a-56f will be recalculated to provide the modified target points 72. In response to the user modification input 46, the offline programming system 14 generates the target robot program 52 based on the candidate target points 56a-56f, the actual reference points 70a-70f and the user modification input 46. The target robot program 52 is then sent from the offline programming system 14 to the robot controller 16 for execution in order to cause the industrial robot 12 to perform movements corresponding to the modified target points 72 in relation to the surface 28. In addition to the modified target points 72a-72f and optionally modified orientations, the target robot program 52 contains movement instructions for the industrial robot 12, such as G-code or RAPID code used by ABB.

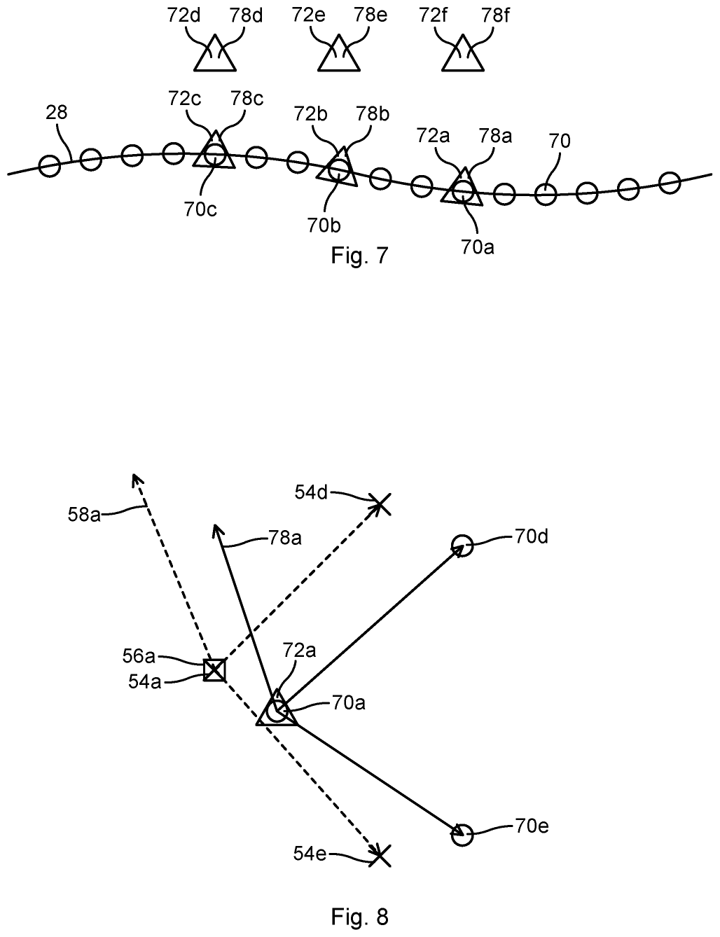

FIG. 7 schematically represents a side view of the surface 28. A plurality of modified target points 72a-72f are positioned in relation to the surface 28. The view in FIG. 7 and similar views may for example be displayed on the display 34. When modifying the candidate target points 56a-56f to provide the modified target points 72, also the candidate orientations 58a-58d may be modified based on the actual reference points 70 (and optionally based on the user modification input 46) to provide modified orientations 78a-78f associated with the modified target points 72a-72f.

As shown in FIG. 7, the first to third modified orientations 78a-78c, associated with the first to third modified target points 72a-72c, are changed with respect to the associated first to third candidate orientations 58a-58c (FIG. 2) such that the print tool 22 can always maintain a perpendicular orientation (or any other desired orientation) relative to the surface 28 during printing. The fourth to sixth modified orientations 78d-78f, associated with the fourth to sixth modified target points 72d-72f, may or may not be modified with respect to the associated candidate target points 56.

FIG. 8 schematically represents the first candidate orientation 58a and the first modified orientation 78a for the print tool 22. FIG. 8 further shows a first candidate reference point 54a, a fourth candidate reference point 54d, a fifth candidate reference point 54e and the first candidate target point 56a associated with the first candidate reference point 54a and having the first candidate orientation 58a. FIG. 8 further shows the first actual reference point 70a associated with the first candidate reference point 54a, a fourth actual reference point 70d associated with the fourth candidate reference point 54d, a fifth actual reference point 70e associated with the fifth candidate reference point 54e, and the first modified target point 72a associated with the first candidate target point 56a and having the first modified orientation 78a.

In this example, the first modified orientation 78a is determined based on the positions of the first actual reference point 70a, the fourth actual reference point 70d and the fifth actual reference point 70e. In this specific and non-limiting example, the first modified orientation 78a is determined as being a normal to a plane comprising the first actual reference point 70a, the fourth actual reference point 70d and the fifth actual reference point 70e. For each actual reference point 70a-70c, a respective modified orientation 78a-78c for the print tool 22 can be determined in this way. The first candidate orientation 58a may be determined in the same way with respect to the first candidate reference point 54a, the fourth candidate reference point 54d and the fifth candidate reference point 54e. The modified orientations 78a-78f may or may not differ from the associated candidate orientations 58a-58f. Also, the candidate orientations 58a-58f and the modified orientations 78a-78f are defined in the offline programming system 14, e.g. in the reference coordinate system 48.

When the target robot program 52 is executed by the robot controller 16, the robot controller 16 controls the industrial robot 12 to position the print tool 22, or other end effector, in each modified target point 72a-72f with the corresponding modified orientation 78a-78f, e.g. to manufacture the object 40 by additive manufacturing. When executing the target robot program 52 in the robot controller 16, the target robot program 52 may be dynamically loaded from the offline programming system 14 to the robot controller 16.

By modifying the candidate target points 56a-56f based on the actual reference points 70a-70c to provide the modified target points 72a-72f before the target robot program 52 is generated, the accuracy of movements of the industrial robot 12 is improved in comparison with modifying an already created target robot program 52. Moreover, the method enables introduction of new functionality based on inputs from the user 42, such as the option for the user 42 to select how the candidate target points 56a-56f should be modified to provide the modified target points 72a-72f. In addition, the method enables efficient modification of an orientation of the print tool 22 in dependence of the true profile of the surface 28. This in turn improves the performance of the industrial robot 12.

While the present disclosure has been described with reference to exemplary embodiments, it will be appreciated that the present invention is not limited to what has been described above. For example, it will be appreciated that the dimensions of the parts may be varied as needed. Accordingly, it is intended that the present invention may be limited only by the scope of the claims appended hereto.

1. A method of controlling movements of an industrial robot in relation to a surface, the method comprising:
providing a plurality of candidate target points for the industrial robot in an offline programming system;
providing a plurality of actual reference points in the offline programming system, the actual reference points being indicative of a true profile of the surface;
modifying the candidate target points in the offline programming system based on the actual reference points to provide a plurality of modified target points for the industrial robot;
providing a target robot program for the industrial robot based on the modified target points; and
executing the target robot program in a robot controller to thereby cause the industrial robot to perform movements in relation to the surface;

2. The method according to claim 1, wherein the modification of the candidate target points is additionally made based on a user modification input indicative of a type of modification of the candidate target points.

3. The method according to claim 1, wherein the provision of the actual reference points comprises:
providing a plurality of candidate reference points; and
determining the actual reference points based on the candidate reference points.

4. The method according to claim 3, wherein the candidate target points are provided based on the candidate reference points.

5. The method according to claim 4, further comprising:
providing, in the offline programming system, a candidate orientation for an end effector of the industrial robot associated with one of the candidate target points;
modifying, in the offline programming system, the candidate orientation based on one or more of the actual reference points to provide a modified orientation for the end effector, different from the candidate orientation; and
associating the modified orientation with the modified target point associated with the one candidate target point;
wherein the target robot program is additionally provided based on the modified orientation.

6. The method according to claim 3, wherein the method comprises:
for each candidate reference point, controlling the industrial robot to move to measure a position of the surface associated with the candidate reference point; and
determining the actual reference points based on the candidate reference points and the measured positions.

7. The method according to claim 6, wherein the method comprises:
providing the candidate reference points in the offline programming system;
providing a measurement robot program for the industrial robot based on the candidate reference points; and
executing the measurement robot program in the robot controller to thereby cause the industrial robot to move to measure the positions of the surface associated with the candidate reference points.

8. The method according to claim 6, further comprising:
selecting a measurement method of the positions of the surface associated with the candidate reference points among a plurality of different measurements methods based on a user measurement input; and
controlling the industrial robot to measure the positions of the surface associated with the candidate reference points based on the selected measurement method.

9. The method according to claim 8, wherein the different measurement methods comprise use of different types of position sensors to be carried by the industrial robot.

10. The method according to claim 1, wherein the target robot program is an additive manufacturing robot program for controlling the industrial robot to perform additive manufacturing on the surface.

11. The method according to claim 1, wherein the movements of the industrial robot in relation to the surface span over at least 2 meters.

12. The method according to claim 1, wherein the industrial robot comprises at least six axes.

13. A robot system comprising:
an industrial robot;
an offline programming system; and
a robot controller;
wherein the offline programming system includes at least one first data processing device and at least one first memory having at least one first computer program stored thereon, the at least one first computer program including program code which, when executed by the at least one first data processing device, causes the at least one first data processing device to perform the steps of:
providing a plurality of candidate target points for the industrial robot;
providing a plurality of actual reference points, the actual reference points being indicative of a true profile of the surface;
modifying the candidate target points based on the actual reference points to provide a plurality of modified target points for the industrial robot;
providing a target robot program for the industrial robot based on the modified target points; and
wherein the robot controller includes at least one second data processing device and at least one second memory having at least one second computer program stored thereon, the at least one second computer program including program code which, when executed by the at least one second data processing device, causes the at least one second data processing device to perform the step of:
executing the target robot program to thereby cause the industrial robot to perform movements in relation to the surface.

14. The method according to claim 2, wherein the provision of the actual reference points comprises:
providing a plurality of candidate reference points; and
determining the actual reference points based on the candidate reference points.

15. The method according to claim 2, wherein the target robot program is an additive manufacturing robot program for controlling the industrial robot to perform additive manufacturing on the surface.

16. The method according to claim 2, wherein the movements of the industrial robot in relation to the surface span over at least 2 meters.

17. The method according to claim 2, wherein the industrial robot comprises at least six axes.

18. The method according to claim 4, wherein the method comprises:
for each candidate reference point, controlling the industrial robot to move to measure a position of the surface associated with the candidate reference point; and
determining the actual reference points based on the candidate reference points and the measured positions.

19. The method according to claim 7, further comprising:
selecting a measurement method of the positions of the surface associated with the candidate reference points among a plurality of different measurements methods based on a user measurement input; and
controlling the industrial robot to measure the positions of the surface associated with the candidate reference points based on the selected measurement method.
